(19) United States
(12) Patent Application Publication
(10) Pub. No.: US 2024/0173629 A1
(43) Pub. Date: May 30, 2024

(54) SELECTING ONE OF MULTIPLE USER DEVICES IN A NETWORK GAMING SYSTEM

(71) Applicant: JUST DO LUCK, INC, Wilmington, DE (US)

(72) Inventor: Artem NILOV, Brussels (BE)

(21) Appl. No.: 17/994,588

(22) Filed: Nov. 28, 2022

(51) Int. Cl. A63F 13/795; A63F 13/35

(52) U.S. Cl. CPC A63F 13/795; A63F 13/35

(57) ABSTRACT

The invention relates to a technique for selecting one user (i.e., winner) from a group of users in a network gaming system via multi-user interaction with a regular central binary event in the network gaming system. This technique involves: selecting, by each user in a certain group, one of two equiprobable values of the binary value; selecting an actual value from the two equiprobable values of the binary event; and comparing the actual value with the value selected by each user. Based on the comparison of the user-selected values with the actual value, the users of the same group are sequentially sorted into winners and losers; the winners advance to the next round or iteration. These steps are repeated until there is only one winner left. By so doing, the multi-user interaction with the binary event may be made equal, fair and simple.

### TECHNICAL FIELD

The present disclosure relates generally to the field of network technologies. In particular, the present disclosure relates to an interactive online service that allows one of multiple user devices to be selected in a network gaming system.

### BACKGROUND

The development of network gaming technologies allows one to organize a simple, large-scale and fair network gaming system that is available to a wide range of users (i.e., players) on equal terms for each user and with absolutely equal chances of winning. This can be a strong motivating factor to take a marketing and entertainment technology to the next level. Furthermore, to interact with such network gaming systems, the users do not need to have any special knowledge and skills. All of this simplify the process of user interaction with such network gaming systems and may require only compliance with the simplest rules, which could significantly expand the audience and the involvement of the users.

However, the existing network interactive gaming technologies still do not practically use the clear opportunities and advantages of interaction with a single central binary event in network gaming systems. For this reason, almost all existing binary gaming technologies are characterized by a limited set of functionalities and have a low scaling potential, which significantly reduces the motivation for users to interact with these technologies, reduces the number, involvement, stickiness of the users, limits the distribution and use of network gaming systems. Thus, the existing binary gaming technologies do not allow organizing interaction between the users on equal terms, which greatly affects the personal interest and activity of the users. This is, in turn, reflected in the limitation of general gaming activities, which entails a lack of opportunities for using network gaming technologies.

Until now, in the existing methods of user interaction with network gaming systems (see, e.g., U.S. Pat. No. 8,708,814 B2, 29 Apr. 2014; U.S. Pat. No. 9,367,988 B2, 14 Jun. 2016; US 2009054127 A1, 26 Feb. 2009; US 2014349732 A1, 27 Nov. 2014; U.S. Pat. No. 7,094,154 B2, 22 Aug. 2006; U.S. Pat. No. 7,532,111 B2, 12 May 2009; and U.S. Pat. No. 8,535,134 B2, 17 Sep. 2013), there has been an almost complete absence of equal, fair and simple user interaction, in which the implemented network gaming system would provide an increase in interest in performing the required gaming actions. This is, in turn, reflected in missed opportunities both by the organizers of such network gaming systems and by the users themselves. In addition, almost all the existing methods of user interaction with network gaming systems involve different probabilities, chances and conditions, which reduces confidence in the interaction process as a whole.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables equal, fair and simple multi-user interaction with a network gaming system, thereby allowing one of users to be ultimately selected as a winner.

The objective above is achieved by the features of the independent claims in the appended claims. Further embodiments and examples are apparent from the dependent claims, the detailed description, and the accompanying drawings.

According to a first aspect, a centralized computing device is provided. The centralized computing device comprises at least one processor, as well as a memory coupled to the at least one processor and configured to store processor-executable instructions. When executed by the at least one processor, the processor-executable instructions cause the at least one processor to operate as follows. At first, the at least one processor receives a user request from each of multiple user devices. The user request comprises a user consent to interact with a binary event and a periodicity of user interaction with the binary event. The binary event is cyclic and comprises two equiprobable values. Then, the at least one processor uses the user requests to organize the multiple user devices into at least one group of user devices. After that, for each group of user devices of the at least one group of user devices, the at least one processor performs the following operations: (a) receive selection data from each user device in the group of user devices during a predefined time period, the selection data comprising one of the two equiprobable values of the binary event; (b) check whether the equiprobable value comprised in the selection data from each user device in the group of user devices is the same; (c) if the equiprobable value comprised in the selection data from each user device in the group of user devices is not the same, select an actual value from the two equiprobable values of the binary event according to a predefined selection algorithm, or receive the actual value from an external source; (d) send the actual value to each user device in the group of user devices; (e) based on the selection data and the actual value, determine whether the group of user devices comprises N user devices each of which has sent the selection data comprising the actual value, where N is a natural number; and (f) if the group of user devices comprises the N user devices and N is more than one, repeat operations (a)-(e) for the N user devices until N is equal to one. The centralized computing device thus configured may provide the effective (in terms of simplicity and fairness) interaction of the user devices (or, in other words, users or players) with a network gaming system (i.e., the binary event). As a result, users may be confident in the absolute honesty and transparency of game processes, which always ensure the determination of the luckiest user-winner from any number of users in a multi-iteration draw. Furthermore, the honesty and equality of user interaction with the binary event is additionally ensured by distributing the users into groups based on the periodicities of interaction indicated in their requests. All this contributes to the creation of always equal conditions and always equal chances to win, which entails the motivation of user interaction with the binary event, their involvement and stickiness, as well as the wide distribution and use of network gaming systems based on binary events.

In one exemplary embodiment of the first aspect, one of the two equiprobable values of the binary event is an odd number, while another of the two equiprobable values of the binary event is an even number. In this embodiment, the binary event may be implemented as an even-odd game, which allows one to quickly and efficiently select, at each iteration of the multiple-iteration draw, those users who have selected the actual value.

In one exemplary embodiment of the first aspect, the at least one processor is configured to perform operations (a)-(e) based on a blockchain technology. By so doing, it is possible to increase the execution efficiency of operations (a)-(f). More specifically, the blockchain technology may make it possible to select the actual value from the two equivalent values of the binary event in a more honest and reliable way.

In one exemplary embodiment of the first aspect, if the equiprobable value comprised in the selection data from each user device in the group of user devices is the same, the at least one processor is further configured to instruct each user device in the group of user device to reselect one of the two equiprobable values of the binary event and resend the selection data to the centralized computing device. By so doing, it is possible to skip operations (c)-(f) and, consequently, avoid the cost of their execution if all the users in the same group have selected the same equiprobable value at the current iteration.

According to a second aspect, a user device is provided. The user device comprises at least one processor, as well as a memory coupled to the at least one processor and configured to store processor-executable instructions. When executed by the at least one processor, the processor-executable instructions cause the at least one processor to operate as follows. At first, the user device sends a user request to a centralized computing device (operation (a)). The user request comprises a user consent to interact with a binary event and a periodicity of user interaction with the binary event. The binary event is cyclic and comprises two equiprobable values. Then, during a predefined time period, the user device sends selection data to the centralized computing device (operation (b)). The selection data comprises one of the two equiprobable values of the binary event. Next, the user device receives an actual value from the centralized computing device (operation (c)). The actual value is one of the two equiprobable values of the binary event. After that, the user device repeats operations (b) and (c) while the selection data sent in operation (b) comprises the actual value (operation (d)). The user device thus configured may participate in the binary event on an equal and fair basis.

In one exemplary embodiment of the second aspect, one of the two equiprobable values of the binary event is an odd number, while another of the two equiprobable values of the binary event is an even number. In this embodiment, the binary event may be implemented as an even-odd game, which allows one to quickly and efficiently select, at each iteration of the multiple-iteration draw, those users who have selected the actual value.

According to a third aspect, a method for operating a centralized computing device is provided. The method starts with the step of receiving a user request from each of multiple user devices. The user request comprises a user consent to interact with a binary event and a periodicity of user interaction with the binary event. The binary event is cyclic and comprises two equiprobable values. Then, the method proceeds to the step of using the user requests to organize the multiple user devices into at least one group of user devices. After that, the following steps are performed with respect to each group of user devices of the at least one group of user devices: (a) receiving selection data from each user device in the group of user devices during a predefined time period, the selection data comprising one of the two equiprobable values of the binary event; (b) checking whether the equiprobable value comprised in the selection data from each user device in the group of user devices is the same; (c) if the equiprobable value comprised in the selection data from each user device in the group of user devices is not the same, selecting an actual value from the two equiprobable values of the binary event according to a predefined selection algorithm, or receiving the actual value from an external source; (d) sending the actual value to each user device in the group of user devices; (e) based on the selection data and the actual value, determining whether the group of user devices comprises N user devices each of which has sent the selection data comprising the actual value, where N is a natural number; and (f) if the group of user devices comprises the N user devices and N is more than one, repeating steps (a)-(e) for the N user devices until N is equal to one. By so doing, it is possible to provide the effective (in terms of simplicity and fairness) interaction of the user devices (or, in other words, users or players) with a network gaming system (i.e., the binary event). As a result, users may be confident in the absolute honesty and transparency of game processes, which always ensure the determination of the luckiest user-winner from any number of users in a multi-iteration draw. Furthermore, the honesty and equality of user interaction with the binary event is additionally ensured by distributing the users into groups based on the periodicities of interaction indicated in their requests. All this contributes to the creation of always equal conditions and equal chances to win, which entails the motivation of user interaction with the binary event, their involvement and stickiness, as well as the wide distribution and use of network gaming systems based on binary events.

In one exemplary embodiment of the third aspect, one of the two equiprobable values of the binary event is an odd number, while another of the two equiprobable values of the binary event is an even number. In this embodiment, the binary event may be implemented as an even-odd game, which allows one to quickly and efficiently select, at each iteration of the multiple-iteration draw, those users who have selected the actual value.

In one exemplary embodiment of the third aspect, steps (a)-(f) are performed based on a blockchain technology. By so doing, it is possible to increase the execution efficiency of steps (a)-(f). More specifically, the blockchain technology may make it possible to select the actual value from the two equivalent values of the binary event in a more honest and reliable way.

In one exemplary embodiment of the third aspect, if the equiprobable value comprised in the selection data from each user device in the group of user devices is the same, the method further comprises the step of instructing each user device in the group of user device to reselect one of the two equiprobable values of the binary event and resend the selection data to the centralized computing device. By so doing, it is possible to skip steps (c)-(f) and, consequently, avoid the cost of their execution if all the users in the same group have selected the same equiprobable value at the current iteration.

According to a fourth aspect, a method for operating a user device is provided. The method starts with step (a), in which the user device sends a user request to a centralized computing device. The user request comprises a user consent to interact with a binary event and a periodicity of user interaction with the binary event. The binary event is cyclic and comprises two equiprobable values. Then, the method goes on to step (b), in which the user device sends selection data to the centralized computing device during a predefined time period. The selection data comprises one of the two equiprobable values of the binary event. Next, the method proceeds to step (c), in which the user device receives an actual value from the centralized computing device. The actual value is one of the two equiprobable values of the binary event. After that, the method proceeds to step (d), in which the user device repeats steps (b) and (c) while the selection data sent in step (b) comprises the actual value. By so doing, the user device may participate in the binary event on an equal and fair basis.

In one exemplary embodiment of the fourth aspect, one of the two equiprobable values of the binary event is an odd number, while another of the two equiprobable values of the binary event is an even number. In this embodiment, the binary event may be implemented as an even-odd game, which allows one to quickly and efficiently select, at each iteration of the multiple-iteration draw, those users who have selected the actual value.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a step-by-step flowchart of interaction between a centralized computing device and user devices; and

FIG. 2 explains how the user devices may be distributed into groups depending on a periodicity of interaction with a binary event.

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein may be implemented in practice by using any numbers of the embodiments provided herein. Furthermore, it should be understood that any embodiment of the present disclosure may be implemented using one or more of the features presented in the appended claims.

The word “exemplary” is used herein in the meaning of “used as an illustration”. Unless otherwise stated, any embodiment described herein as “exemplary” should not be construed as preferable or having an advantage over other embodiments.

As used in the exemplary embodiment disclosed herein, a centralized computing device may refer to a remote server that is configured to provide certain one or more online services to remotely connected users over a network, such as the Internet.

According to the exemplary embodiments disclosed herein, a user device or User Equipment (UE) may refer to an electronic computing device that is configured to perform wireless communications with the centralized computing device. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IOT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

The exemplary embodiments disclosed herein relate to a technique for selecting one user or player (i.e., winner) from a group of users in a network gaming system via multi-user interaction with a regular central binary event in the network gaming system. This technique involves: selecting, by each user in a certain group, one of two equiprobable variants or values of the binary value; selecting an actual (random) value from the two equiprobable values of the binary event; and comparing the actual value with the value selected by each user in the same game group. The binary event is an event that is centralized and the same for all users, games and/or game groups. Based on the comparison of the user-selected values with the actual value, the users of the same group are sequentially sorted into winners and losers; the winners advance to the next round or iteration. These steps are repeated until there is only one winner left. By so doing, the multi-user interaction with the binary event may be made equal, fair and simple.

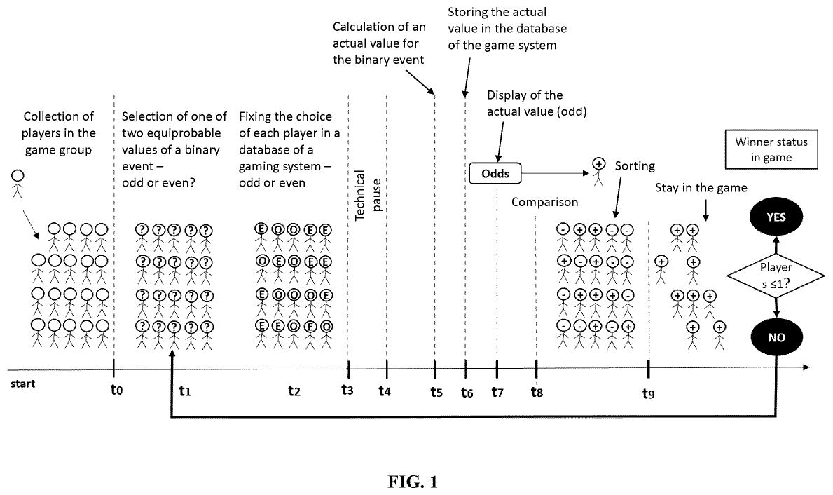

FIG. 1 shows a step-by-step flowchart of interaction between a centralized computing device and user devices.

At time instant t0, all users or players are collected into game groups (an arbitrary number N of players in each group). More specifically, each user sends a user request from his/her user device to the centralized computing device. The user request comprises a user consent to participate in a binary event and a periodicity of such interaction (e.g., every 5 min, 10 min, etc.). The binary event is cyclic (i.e., recurring in cycles) and comprises two equiprobable values. If the two equiprobable values are represented by odd and even numbers, then the binary event may be implemented as an even-odd game. If the two equiprobable values are represented by the heads and tails of a coin, then the binary event may be implemented as a heads and tails game. At the same time, it should be noted that the present disclosure is not limited to these implementations of the binary event; in some other embodiments, the binary event based on other two equiprobable values (e.g., positive and negative numbers, black and white colors, etc.) may be used.

Next, during a predefined time period (from t0 to t1), each player selects one of the two equiprobable values of the binary event by using a game interface installed on his/her user device or available at a certain website. The user device of each player may be configured to use a certain predefined time period for this purpose. Alternatively, the centralized computing device may report the predefined time period to each of the user devices after the centralized computing device has received the user requests therefrom. The predefined time period may be displayed through the game interface. The values are always equally likely (50% to 50%) for each player. The selection is made by each player individually up to a certain point in time (i.e., t1). Up to this point, each player may change his/her choice at will an unlimited number of times.

Once the user has selected one of the two equiprobable values, it is sent as selection data from the user device to the centralized computing device. The selected equiprobable value from each player is recorded in a database of a gaming system, starting from time instant t2. Said recording is performed until time instant t3. The player may change his/her selection until t3. After its occurrence, the choices of all players or users are recorded in the database of the gaming system. During a technical pause (i.e., between time instants t3 and t4), no player selections are accepted unless they are made, and do not change if they are already done. If the player has not selected one of the two equiprobable values of the binary event for any reason, then his/her selection may be carried over from the previous round/iteration of the game.

After time instant t4, the centralized computing device automatically starts a next technical pause. This technical pause is necessary for the binary event to work correctly.

After the end of the technical pause (i.e., time instant t5), the centralized computing device selects/calculates the actual value of the binary event. The actual value is one of the two equiprobable values of the binary event. In one embodiment, the centralized computing device may make this selection according to a predefined selection algorithm, e.g., any random number generator or blockchain-based algorithm. The selection algorithm may be implemented as an open public open-source calculation algorithm. In another embodiment, the centralized computing device may receive the actual value from an external source (e.g., from another centralized computing device). When the actual value appears, it is fixed and stored in the database of the gaming system at time instant t6. Then, the centralized computing device sends the actual value to each user (i.e., his/her user device) in the game group at time instant t7. For example, the actual value may be displayed through the game interface to each user via the Internet.

Next, at time instant t8, the centralized computing device (automatically and simultaneously) compares the single actual value generated for all players with the values selected by all the players. If the selection made by a particular player matches the actual value, he/she is assigned the status of a winner in a current round; in case of a mismatch, the status of a loser in the round. In FIG. 1, it is assumed that the binary event is an even-odd game, and the actual value is “ODD”, for which reason those players who have initially selected “ODD” (before time instant t3) are winners in the current round (i.e., they keep playing and advance to the next round).

Based on this comparison, the players are sorted, at time instant t9, into those whose selection result coincided (winners) with the actual value of the binary event, and those who did not match (losers). Thus, each initial game group of players is divided into two groups—a group of winners and a group of losers.

If there is more than one winner in the group of winners in the current round, the next round of the game is activated, i.e., iteration is carried out with repetition of all the above-mentioned operations according to the flowchart of FIG. 1. Iterations are repeated until there is only one winner from the original game group.

A disputable situation is possible in the game, when in one of the rounds all players of the same group have selected the same value of the binary event (everyone bet on odd). In this case, the whole group skips this round, the centralized computing device automatically transfers the players of this game group in the same composition to the next round in which they continue to participate in the draw on a common basis (i.e., in accordance with the flowchart of FIG. 1).

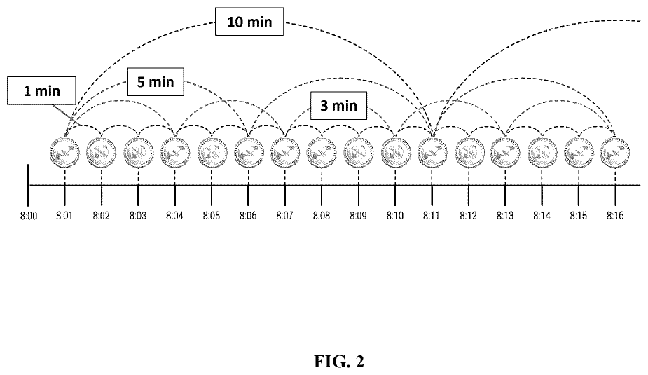

FIG. 2 explains how user devices may be distributed into groups depending on the periodicity of interaction with the binary event. In particular, if the user requests from some users comprise the same periodicity of interaction which is, for example, set to “every 3 min”, then these users are combined into one group.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A centralized computing device comprising:
at least one processor; and
a memory coupled to the at least one processor and configured to store processor-executable instructions,
wherein the at least one processor is configured, when executing the processor-executable instructions, to:
receive a user request from each of multiple user devices, the user request comprising a user consent to interact with a binary event and a periodicity of user interaction with the binary event, the binary event being cyclic and comprising two equiprobable values;
based on the user requests, organize the multiple user devices into at least one group of user devices; and
for each group of user devices of the at least one group of user devices:
(a) receive selection data from each user device in the group of user devices during a predefined time period, the selection data comprising one of the two equiprobable values of the binary event;
(b) check whether the equiprobable value comprised in the selection data from each user device in the group of user devices is the same;
(c) if the equiprobable value comprised in the selection data from each user device in the group of user devices is not the same, select an actual value from the two equiprobable values of the binary event according to a predefined selection algorithm, or receive the actual value from an external source;
(d) send the actual value to each user device in the group of user devices;
(e) based on the selection data and the actual value, determine whether the group of user devices comprises N user devices each of which has sent the selection data comprising the actual value, where N is a natural number; and
(f) if the group of user devices comprises the N user devices and N is more than one, repeat operations (a)-(e) for the N user devices until N is equal to one.

2. The device of claim 1, wherein one of the two equiprobable values of the binary event is an odd number, while another of the two equiprobable values of the binary event is an even number.

3. The device of claim 1, wherein the at least one processor is configured to perform operations (a)-(f) based on a blockchain technology.

4. The device of claim 1, wherein the at least one processor is further configured to:
if the equiprobable value comprised in the selection data from each user device in the group of user devices is the same, instruct each user device in the group of user device to reselect one of the two equiprobable values of the binary event and resend the selection data to the centralized computing device.

5. A user device comprising:
at least one processor; and
a memory coupled to the at least one processor and configured to store processor-executable instructions,
wherein the at least one processor is configured, when executing the processor-executable instructions, to:
(a) send a user request to a centralized computing device, the user request comprising a user consent to interact with a binary event and a periodicity of user interaction with the binary event, the binary event being cyclic and comprising two equiprobable values;
(b) during a predefined time period, send selection data to the centralized computing device, the selection data comprising one of the two equiprobable values of the binary event;
(c) receive an actual value from the centralized computing device, the actual value being one of the two equiprobable values of the binary event; and
(d) repeat operations (b) and (c) while the selection data sent in operation (b) comprises the actual value.

6. The device of claim 5, wherein one of the two equiprobable values of the binary event is an odd number, while another of the two equiprobable values of the binary event is an even number.

7. A method for operating a centralized computing device, comprising:
receiving a user request from each of multiple user devices, the user request comprising a user consent to interact with a binary event and a periodicity of user interaction with the binary event, the binary event being cyclic and comprising two equiprobable values; based on the user requests, organizing the multiple user devices into at least one group of user devices; and
for each group of user devices of the at least one group of user devices:
(a) receiving selection data from each user device in the group of user devices during a predefined time period, the selection data comprising one of the two equiprobable values of the binary event;
(b) checking whether the equiprobable value comprised in the selection data from each user device in the group of user devices is the same;
(c) if the equiprobable value comprised in the selection data from each user device in the group of user devices is not the same, selecting an actual value from the two equiprobable values of the binary event according to a predefined selection algorithm, or receiving the actual value from an external source;
(d) sending the actual value to each user device in the group of user devices;
(e) based on the selection data and the actual value, determining whether the group of user devices comprises N user devices each of which has sent the selection data comprising the actual value, where N is a natural number;
(f) if the group of user devices comprises the N user devices and N is more than one, repeating steps (a)-(e) for the N user devices until N is equal to one.

8. The method of claim 7, wherein one of the two equiprobable values of the binary event is an odd number, while another of the two equiprobable values of the binary event is an even number.

9. The method of claim 7, wherein steps (a)-(f) are performed based on a blockchain technology.

10. The method of claim 7, further comprising:
if the equiprobable value comprised in the selection data from each user device in the group of user devices is the same, instructing each user device in the group of user device to reselect one of the two equiprobable values of the binary event and resend the selection data to the centralized computing device.

11. A method for operating a user device, comprising:
(a) sending a user request to a centralized computing device, the user request comprising a user consent to interact with a binary event and a periodicity of user interaction with the binary event, the binary event being cyclic and comprising two equiprobable values;
(b) during a predefined time period, sending selection data to the centralized computing device, the selection data comprising one of the two equiprobable values of the binary event;
(c) receiving an actual value from the centralized computing device, the actual value being one of the two equiprobable values of the binary event; and
(d) repeating steps (b) and (c) while the selection data sent in step (b) comprises the actual value.

12. The method of claim 11, wherein one of the two equiprobable values of the binary event is an odd number, while another of the two equiprobable values of the binary event is an even number.
